(19) United States
(12) Patent Application Publication
(10) Pub. No.: US 2015/0362632 A1
(43) Pub. Date: Dec. 17, 2015

(54) ANTIREFLECTION COATING AND OPTICAL ELEMENT INCLUDING THE SAME

(71) Applicant: CANON KABUSHIKI KAISHA, Tokyo (JP)

(72) Inventor: Kazue Uchida, Utsunomiya-shi (JP)

(21) Appl. No.: 14/737,820

(22) Filed: Jun. 12, 2015

(30) Foreign Application Priority Data
Jun. 16, 2014 (JP) 2014-123275

(51) Int. Cl. G02B 1/115

(52) U.S. Cl. CPC G02B 1/115

(57) ABSTRACT

Provided is an antireflection coating to be formed on a substrate comprising a first layer, a second layer, a third layer and a fourth layer that are laminated in order from the substrate side to the air side. In the antireflection coating, a refractive index of material of the substrate for the reference wavelength of 550 nm ns, a refractive index of material of the first layer for the reference wavelength of 550 nm n1, a physical film thickness of the first layer d1, a refractive index of material of the fourth layer n4, and a physical film thickness of the fourth layer d4 are appropriately set.

### BACKGROUND OF THE INVENTION

1. Field of the Invention

The present invention relates to an antireflection coating and an optical element including the antireflection coating, which are suitably used in an optical system of a digital camera, a video camera, a TV camera or the like.

2. Description of the Related Art

Many optical elements such as lenses and filters included in optical systems are manufactured using transparent members (substrates) such as optical glasses and optical plastics. In such a substrate, a high refractive index leads to high reflectances on the light incidence surface and the light emission surface (the light incidence/emission surfaces). When an optical element having a high reflectance on the light incidence/emission surface is used in an optical system, the quantity of the effective light to reach the image plane is reduced. Therewith, an unnecessary reflection reflected by the light incidence/emission surface of the optical element enters the image plane and becomes a ghost or a flare, causing the decrease in the optical performance of the optical system. Therefore, in the optical element, an anti-reflection function is added to the light incidence surface.

The unnecessary ghost or flare to be reflected by the light incidence/emission surface and to reach the image plane greatly varies depending on the incident angle of the light flux to the optical element and the shape of the optical element. Therefore, an antireflection coating to be added to the substrate is demanded to provide a good anti-reflection effect in the broadest possible wavelength band and for various incident angles. As the antireflection coating to be added to the light incidence/emission surface of the substrate, there is known a multi-layer antireflection coating in which multiple thin dielectric films are laminated by deposition on the light incidence/emission surface of the substrate.

Meanwhile, as the material to be used for the deposited film, for example, a material having a lower refractive index than magnesium fluoride, which has a refractive index of 1.38, is used for the outermost layer (the side closest to an air layer) of the antireflection coating. Thereby, a high-performance anti-reflection function can be easily obtained. In addition, it is known that an inorganic material such as silica and magnesium fluoride and an organic material such as silicone resin and amorphous fluoride resin are used as the material having a lower refractive index. These materials can reduce the refractive index by forming voids in the layer.

Conventionally, there is known a four-layer antireflection coating adopting, as topmost layer, a magnesium fluoride layer in which voids are provided in the layer and thereby the refractive index is reduced to 1.25 (Japanese Patent Application Laid-Open No. 2005-284040).

In order to reduce the reflectance in a broadband wavelength region (visible wavelength region) of a wavelength of 400 nm to a wavelength of 700 nm and to obtain a good anti-reflection function, it is important to adequately set the refractive index of the substrate, the refractive index and film thickness of the material of the thin film to be added to the substrate, the number of layers, and the like. When the construction is inadequate, it is difficult to obtain a good anti-reflection effect in the broadband wavelength region.

In the antireflection coating disclosed in Japanese Patent Application Laid-Open No. 2005-284040, the reflectance for the light in the visible wavelength region is about 0.4%, and the anti-reflection performance is not always sufficient. Furthermore, only a film construction formed on a substrate having a refractive index of 1.52 is disclosed. For the optical element such as a lens that is included in the optical system, glass materials having various refractive indexes are used. In some cases, for example, a glass matter having a refractive index of 1.65 or higher is used in a large amount. Therefore, it is unclear whether the antireflection coating in Japanese Patent Application Laid-Open No. 2005-284040 provides a sufficient anti-reflection performance for a construction in which the refractive index of the material of the substrate is 1.65 or higher.

### SUMMARY OF THE INVENTION

An object of the present invention is to provide an antireflection coating having a good anti-reflection performance in the broadband wavelength region, and an optical element including the antireflection coating.

An antireflection coating to be formed on a substrate according to the present invention comprises a first layer, a second layer, a third layer and a fourth layer that are laminated in order from the substrate side to the air side, the antireflection coating satisfies the following conditional expressions:

ns≧1.65

1.3≦n1≦1.7

n1≦ns

1.15≦n4≦1.30

0.018λ≦nl×d1≦0.125λ

0.18λ≦n4×d4≦0.27λ

where λ represents a reference wavelength of 550 nm, ns represents a refractive index of material of the substrate for the reference wavelength, n1 represents a refractive index of material of the first layer for the reference wavelength, d1 (nm) represents a physical film thickness of the first layer, n4 represents a refractive index of material of the fourth layer, and d4 (nm) represents a physical film thickness of the fourth layer.

Further features of the present invention will become apparent from the following description of exemplary embodiments with reference to the attached drawings.

### BRIEF DESCRIPTION OF THE DRAWINGS

FIG. 1 is a schematic cross-section view illustrating an embodiment of an optical element according to the present invention.

FIG. 2 illustrates the reflectance characteristic of an optical element in Example 1 of the present invention.

FIG. 3 illustrates the reflectance characteristic of an optical element in Example 2 of the present invention.

FIG. 4 illustrates the reflectance characteristic of an optical element in Example 3 of the present invention.

FIG. 5 illustrates the reflectance characteristic of an optical element in Example 4 of the present invention.

FIG. 6 illustrates the reflectance characteristic of an optical element in Example 5 of the present invention.

FIG. 7 illustrates the reflectance characteristic of an optical element in Example 6 of the present invention.

FIG. 8 illustrates the reflectance characteristic of an optical element in Example 7 of the present invention.

FIG. 9 illustrates the reflectance characteristic of an optical element in Example 8 of the present invention.

FIG. 10 is a cross-section view of an optical system using an optical element that includes an antireflection coating according to the present invention.

FIG. 11 illustrates the reflectance characteristic of an optical element in Comparative Example 1.

### DESCRIPTION OF THE EMBODIMENTS

Hereinafter, exemplary embodiments of the present invention will be described in detail, with reference to the accompanying drawings. An antireflection coating according to the present invention is a four-layer antireflection coating that is formed on at least one surface of the light incidence surface and light emission surface of a substrate, and the antireflection coating includes four layers of a first layer, a second layer, a third layer and a fourth layer, in order from the substrate side to the air side. Then, the refractive indexes and optical film thicknesses of the materials of the first to fourth layers are adequately set.

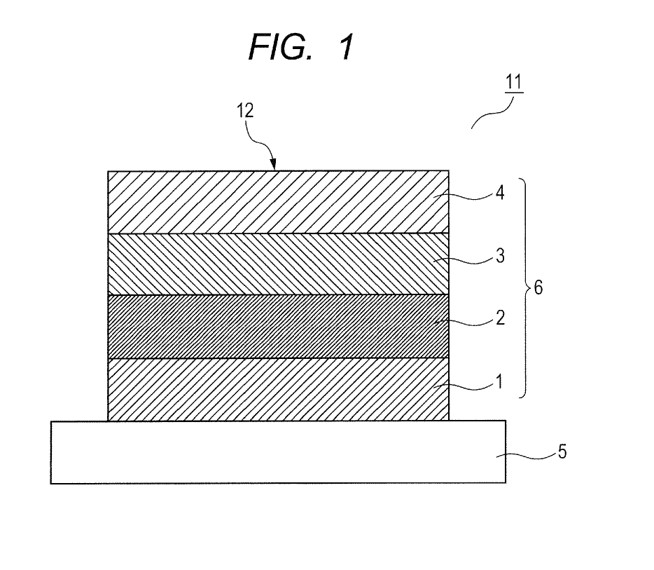

FIG. 1 is a schematic view of an antireflection coating according to an embodiment of the present invention that is added to one surface of a substrate. FIG. 1 illustrates an optical element 11, a transparent substrate 5, an antireflection coating 6 and an air layer 12. The optical element 11 includes a lens, a filter and the like, and includes the antireflection coating 6 on at least one surface of the light incidence surface and light emission surface of the substrate 5.

The optical element 11 includes the substrate 5 and the antireflection coating 6 in which thin films of a first layer 1, a second layer 2, a third layer 3 and a fourth layer 4 are laminated in order from the substrate 5 to the air layer 12. Here, the refractive index of the material of each layer is the refractive index for a reference wavelength. Further, the optical film thickness is as follows.

Optical Film Thickness=(Refractive Index for Reference Wavelength)×(Physical Film Thickness)

A reference wavelength λ is 550 nm. The refractive index of the material of the substrate 5 is represented as ns, the refractive index of the material of the first layer 1 is represented as n1, and the physical film thickness of the first layer 1 is represented as d1 (nm). The refractive index of the material of the fourth layer 4 is represented as n4, and the physical film thickness of the fourth layer 4 is represented as d4 (nm).

In this case, the following conditional expressions are satisfied.

$$\begin{matrix}ns \geq 1.65 \\ 1.3 \leq n 1 \leq 1.7 \\ n 1 \leq ns \\ 1.15 \leq n 4 \leq 1.30 \\ 0.018 λ \leq n 1 \times d 1 \leq 0.125 λ … ( 1 a ) \\ 0.18 λ \leq n 4 \times d 4 \leq 0.27 λ\end{matrix} ) \qquad ( 1 )$$

The antireflection coating according to the present invention satisfies all of the conditional expressions (1), and thereby obtains a high anti-reflection performance in the broadband. Particularly, when the optical film thickness n1×d1 of the first layer 1, which is specified by a conditional expression (1a) of the conditional expressions (1), is 0.125λ (=λ/8) or greater, it is difficult to obtain an antireflection coating having a high anti-reflection performance in the broadband, even if the film thickness of each layer is optimized. Further, when the optical film thickness n1×d1 of the first layer 1 in the conditional expression (1a) is 0.018λ or less, it is difficult to form an uniform film. Furthermore, in the antireflection coating according to the present invention, the refractive index of the material of the second layer 2 is represented as n2, and the physical film thickness of the second layer 2 is represented as d2 (nm). The refractive index of the material of the third layer 3 is represented as n3, and the physical film thickness of the third layer 3 is represented as d3 (nm).

In this case, the following conditional expressions are satisfied.

$$\begin{matrix}0.018 λ \leq n 2 \times d 2 \leq 0.128 λ \\ 0.018 λ \leq n 3 \times d 3 \leq 0.320 λ \\ 1.8 \leq n 2 \leq 2.2 \\ 1.3 \leq n 3 \leq 1.7\end{matrix} ) \qquad ( 2 )$$

The conditional expressions (2) are conditions under which, in the possible range of the optical film thickness, the reflectance characteristic to be determined by the combination of the refractive indexes and optical film thicknesses of the materials of the second layer 2 and the third layer 3 has a high anti-reflection performance in the broadband. In the case of being out of the conditional expressions (2), it is difficult to obtain an antireflection coating having a high anti-reflection performance in the broadband. Preferably, the following is suitable.

0.018λ≦n2×d2≦0.073λ

In the case of exceeding the upper limit of this range, the reflectance at an incidence of 0 degrees and at a wavelength of 400 nm tends to increase.

Next, the characteristics other than the above of the antireflection coating according to the present invention will be described. The fourth layer 4, which is the topmost layer, is formed of an inorganic material such as silica and magnesium fluoride and an organic material such as silicone resin and amorphous fluoride resin, and is a layer that includes voids in the interior. The refractive index is reduced depending on the ratio of the air (a refractive index of 1.0) contained by the voids in the interior. Furthermore, the fourth layer 4 can be a film in which hollow fine particles as the main component are combined by a binder. Here, the main component is a component having the greatest volume ratio.

The hollow fine particle has a void in the interior, and therefore can prevent the adsorption of moisture and impurities to the void. Therefore, the environmental resistance is improved, and it is possible to obtain a stable anti-reflection characteristic with less change in refractive index. For reducing the refractive index of the topmost layer, the material of the hollow fine particle can be a material having a low refractive index, as exemplified by silicon oxide (SiO₂) and magnesium fluoride (MgF₂). Further, the hollow fine particles need to be combined by the binder, and can be produced by a sol-gel method.

In the embodiment, the coating method for providing the antireflection coating on the substrate is not particularly limited, and a typical coating method with a coating liquid, as exemplified by a dip coating method, a spin coating method, a spray coating method and a roll coating method, can be used. In order that a film with an uniform film thickness can be formed on a base material having a curved surface such as a lens, a film formation by a spin coating with a coating material can be adopted. After the coating, the drying is performed. For the drying, a drier, a hot plate, an electric furnace or the like can be used. As the drying condition, a temperature and time having levels that do not influence the base material and that enable the organic solvent within the hollow fine particle to evaporate are adopted.

Typically, a temperature of 300° C. or less can be used. Ordinary, the number of times of the coating can be one, but the drying and the coating may be repeated multiple times.

The first layer 1 to the third layer 3, which are inorganic films, can be formed by a vacuum deposition method or a sputtering method, for the simplification of the film formation. Further, the second layer 2 can be formed of at least one of oxides of titanium, tantalum, zirconia, chromium, niobium, cerium, hafnium and yttrium.

As described above, according to the present invention, it is possible to obtain an antireflection coating having a high anti-reflection performance on the surface of a substrate of a material having a refractive index of 1.65 or higher, and to obtain an optical element including the antireflection coating.

Specific examples of the antireflection coating according to the present invention are shown below. However, they are just examples, and the example of the present invention is not limited to the conditions.

### Example 1

In Example 1, on a substrate of the trade name of S-LAH58 (OHARA INC., trade name, the refractive index of the material is 1.89 (wavelength λ=550 nm)), an antireflection coating having the construction shown in FIG. 1 was produced so as to have a film construction shown in Table 1. On this occasion, the first layer 1 to the third layer 3 were formed by the vacuum deposition method. The main components of the first layer 1 and the third layer 3 were Al₂O₃, and the main component of the second layer 2 was Ta₂O₅. For the fourth layer 4, a binder solution was added to a hollow SiO₂-containing solution such that the refractive index for wavelength λ=550 nm became 1.23, the coating with the mixed and prepared liquid was performed by a spin coater, and the baking was performed by a clean oven at 100 to 250° C. for one hour.

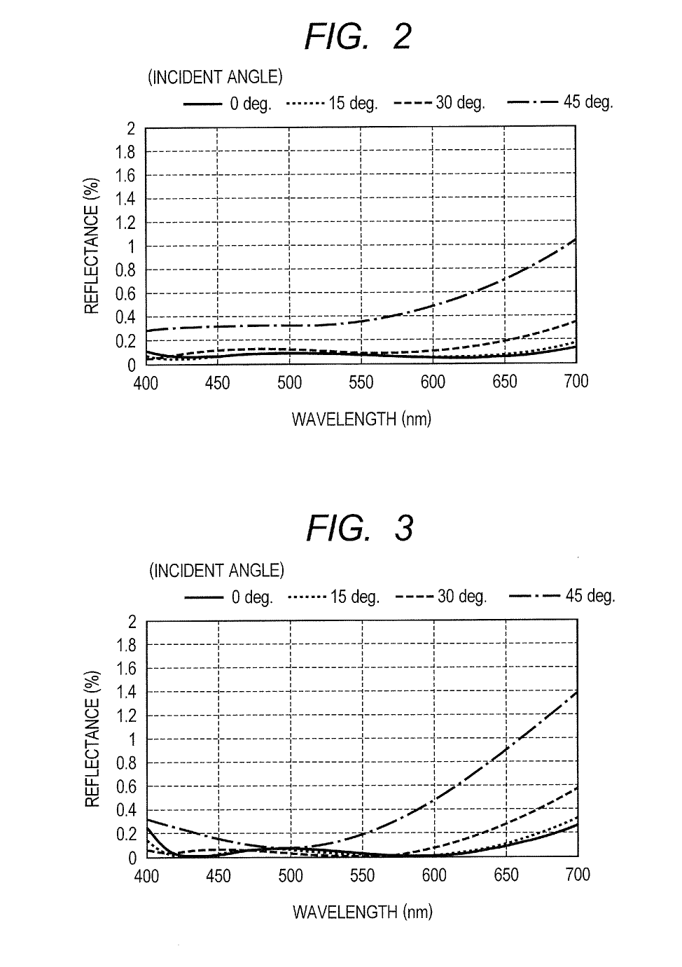

FIG. 2 illustrates the reflectance characteristics at incident angles of 0 degrees, 15 degrees, 30 degrees and 45 degrees, in a wavelength range of 400 nm to 700 nm. In the antireflection coating according to the example, in the wavelength range of 400 nm to 700 nm, the maximum value of the reflectances at the incident angles of 0 degrees, 15 degrees and 30 degrees was 0.4% or less, and even at the incident angle of 45 degrees, the reflectance was 1.1% or less. It is found that the antireflection coating according to the example is a high-performance antireflection coating having a high anti-reflection effect in the broadband.

TABLE 1

| | | Refractive index | Optical film |
|---|---|---|---|
| | Material | (λ = 550 nm) | thickness (nm) |
| Fourth layer | Hollow SiO₂ | 1.23 | 0.240 λ |
| Third layer | Al₂O₃ | 1.63 | 0.267 λ |
| Second layer | Ta₂O₅ | 2.12 | 0.061 λ |
| First layer | Al₂O₃ | 1.63 | 0.035 λ |
| Substrate | S-LAH58 | 1.89 | |

### Example 2

In Example 2, on a substrate of the trade name of S-LAH65v (OHARA INC., trade name, the refractive index of the material is 1.81 (wavelength λ=550 nm)), an antireflection coating having the construction shown in FIG. 1 was produced so as to have a film construction shown in Table 2. On this occasion, the first layer 1 to the third layer 3 were formed by the vacuum deposition method. The main component of the first layer 1 was MgF₂, the main component of the second layer 2 was Ta₂O₅, and the main component of the third layer 3 was Al₂O₃. For the fourth layer 4, a binder solution was added to a hollow MgF₂-containing solution such that the refractive index for wavelength λ=550 nm became 1.20, the coating with the mixed and prepared liquid was performed by the spin coater, and the baking was performed by the clean oven at 100 to 250° C. for one hour.

FIG. 3 illustrates the reflectance characteristics at incident angles of 0 degrees, 15 degrees, 30 degrees and 45 degrees, in a wavelength range of 400 nm to 700 nm. In the antireflection coating according to the example, in the wavelength range of 400 nm to 700 nm, the maximum value of the reflectances at the incident angles of 0 degrees, 15 degrees and 30 degrees was 0.6% or less, and even at the incident angle of 45 degrees, the reflectance was 1.5% or less. It is found that the antireflection coating according to the example is a high-performance antireflection coating having a high anti-reflection effect in the broadband.

TABLE 2

| | | Refractive index | Optical film |
|---|---|---|---|
| | Material | (λ = 550 nm) | thickness (nm) |
| Fourth layer | Hollow MgF₂ | 1.20 | 0.248 λ |
| Third layer | Al₂O₃ | 1.63 | 0.290 λ |
| Second layer | Ta₂O₅ | 2.12 | 0.081 λ |
| First layer | MgF₂ | 1.38 | 0.026 λ |
| Substrate | S-LAH65v | 1.81 | |

### Example 3

In Example 3, on a substrate of the trade name of S-LAH79 (OHARA INC., trade name, the refractive index of the material is 2.01 (wavelength λ=550 nm)), an antireflection coating having the construction shown in FIG. 1 was produced so as to have a film construction shown in Table 3. The first layer 1 to the third layer 3 were formed by the vacuum deposition method. For the fourth layer 4, the coating with a hollow SiO₂ mixed and prepared liquid was performed by the spin coater, and thereafter, the film formation was performed by a one-hour baking. The main component of the first layer 1 was SiO₂, the main component of the second layer 2 was Ta₂O₅, and the main component of the third layer 3 was Al₂O₃.

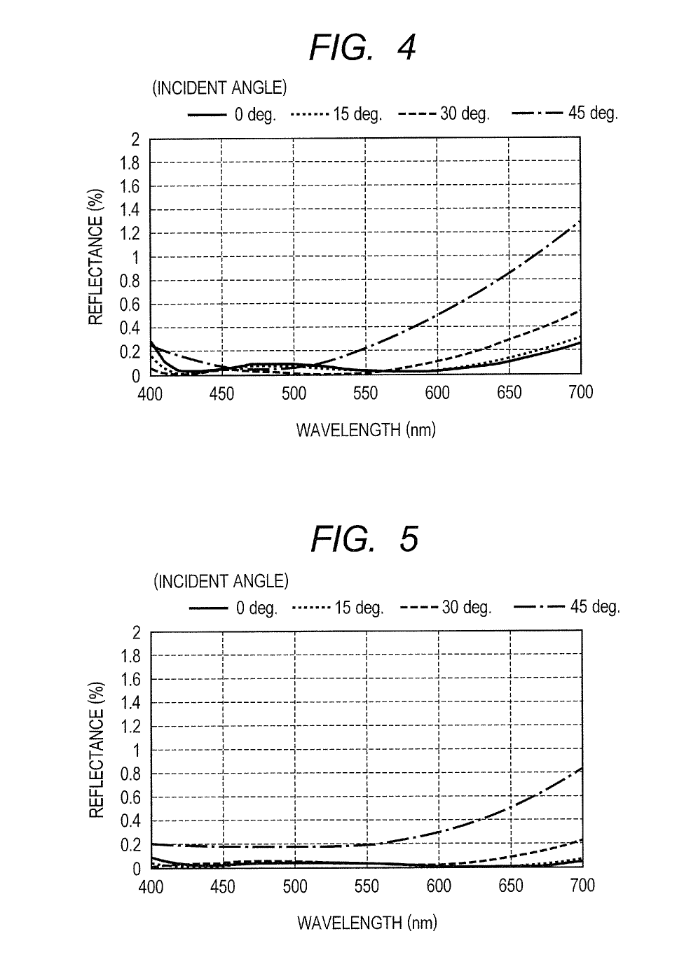

FIG. 4 illustrates the reflectance characteristics at incident angles of 0 degrees, 15 degrees, 30 degrees and 45 degrees, in a wavelength range of 400 nm to 700 nm. In the antireflection coating according to the example, in the wavelength range of 400 nm to 700 nm, the maximum value of the reflectances at the incident angles of 0 degrees, 15 degrees and 30 degrees was 0.6% or less, and even at the incident angle of 45 degrees, the reflectance was 1.4% or less. It is found that the antireflection coating according to the example is a high-performance antireflection coating having a high anti-reflection effect in the broadband.

TABLE 3

| | | Refractive index | Optical film |
|---|---|---|---|
| | Material | (λ = 550 nm) | thickness (nm) |
| Fourth layer | Hollow SiO₂ | 1.20 | 0.251 λ |
| Third layer | Al₂O₃ | 1.68 | 0.273 λ |
| Second layer | Ta₂O₅ | 2.12 | 0.127 λ |
| First layer | SiO₂ | 1.46 | 0.027 λ |
| Substrate | S-LAH79 | 2.01 | |

### Example 4

In Example 4, on a substrate of the trade name of S-LAH79 (OHARA INC., trade name, the refractive index of the material is 2.01 (wavelength λ=550 nm)), an antireflection coating having the construction shown in FIG. 1 was produced so as to have a film construction shown in Table 4. The first layer 1 to the third layer 3 were formed by the vacuum deposition method. For the fourth layer 4, the coating with a hollow SiO₂ mixed and prepared liquid was performed by the spin coater, and thereafter, the film formation was performed by a one-hour baking. The main components of the first layer 1 and the third layer 3 were Al₂O₃, and the main component of the second layer 2 was Ta₂O₅.

FIG. 5 illustrates the reflectance characteristics at incident angles of 0 degrees, 15 degrees, 30 degrees and 45 degrees, in a wavelength range of 400 nm to 700 nm. In the antireflection coating according to the example, in the wavelength range of 400 nm to 700 nm, the maximum value of the reflectances at the incident angles of 0 degrees, 15 degrees and 30 degrees was 0.3% or less, and even at the incident angle of 45 degrees, the reflectance was 1.0% or less. It is found that the antireflection coating according to the example is a high-performance antireflection coating having a high anti-reflection effect in the broadband.

TABLE 4

| | | Refractive index | Optical film |
|---|---|---|---|
| | Material | (λ = 550 nm) | thickness (nm) |
| Fourth layer | Hollow SiO₂ | 1.20 | 0.244 λ |
| Third layer | Al₂O₃ | 1.63 | 0.254 λ |
| Second layer | Ta₂O₅ | 2.12 | 0.092 λ |
| First layer | Al₂O₃ | 1.63 | 0.030 λ |
| Substrate | S-LAH79 | 2.01 | |

### Example 5

In Example 5, on a substrate of the trade name of S-LAH58 (OHARA INC., trade name, the refractive index of the material is 1.89 (wavelength λ=550 nm)), an antireflection coating having the construction shown in FIG. 1 was produced so as to have a film construction shown in Table 5. The first layer 1 to the third layer 3 were formed by the vacuum deposition method. For the fourth layer 4, the coating with a hollow SiO₂ mixed and prepared liquid was performed by the spin coater, and thereafter, the film formation was performed by a one-hour baking. The main components of the first layer 1 and the third layer 3 were Al₂O₃, and the main component of the second layer 2 was Ta₂O₅.

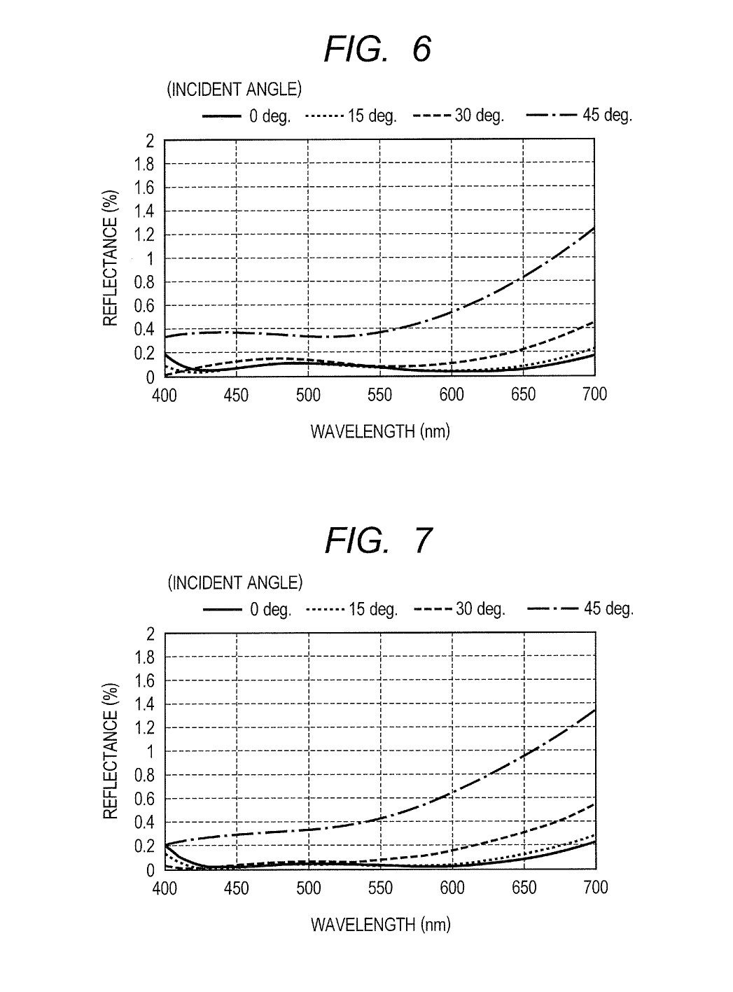

FIG. 6 illustrates the reflectance characteristics at incident angles of 0 degrees, 15 degrees, 30 degrees and 45 degrees, in a wavelength range of 400 nm to 700 nm. In the antireflection coating according to the example, in the wavelength range of 400 nm to 700 nm, the maximum value of the reflectances at the incident angles of 0 degrees, 15 degrees and 30 degrees was 0.5% or less, and even at the incident angle of 45 degrees, the reflectance was 1.4% or less. It is found that the antireflection coating according to the example is a high-performance antireflection coating having a high anti-reflection effect in the broadband.

TABLE 5

| | | Refractive index | Optical film |
|---|---|---|---|
| | Material | (λ = 550 nm) | thickness (nm) |
| Fourth layer | Hollow SiO₂ | 1.25 | 0.244 λ |
| Third layer | Al₂O₃ | 1.68 | 0.281 λ |
| Second layer | Ta₂O₅ | 2.12 | 0.073 λ |
| First layer | Al₂O₃ | 1.63 | 0.030 λ |
| Substrate | S-LAH58 | 1.89 | |

### Example 6

In Example 6, on a substrate of the trade name of S-LAH66 (OHARA INC., trade name, the refractive index of the material is 1.78 (wavelength λ=550 nm)), an antireflection coating having the construction shown in FIG. 1 was produced so as to have a film construction shown in Table 6. The first layer 1 to the third layer 3 were formed by the vacuum deposition method. For the fourth layer 4, the coating with a hollow MgF₂ mixed and prepared liquid was performed by the spin coater, and thereafter, the film formation was performed by a one-hour baking. The main components of the first layer 1 and the third layer 3 were SiO₂, and the main component of the second layer 2 was Ta₂O₅.

FIG. 7 illustrates the reflectance characteristics at incident angles of 0 degrees, 15 degrees, 30 degrees and 45 degrees, in a wavelength range of 400 nm to 700 nm. In the antireflection coating according to the example, in the wavelength range of 400 nm to 700 nm, the maximum value of the reflectances at the incident angles of 0 degrees, 15 degrees and 30 degrees was 0.6% or less, and even at the incident angle of 45 degrees, the reflectance was 1.4% or less. It is found that the antireflection coating according to the example is a high-performance antireflection coating having a high anti-reflection effect in the broadband.

TABLE 6

| | | Refractive index | Optical film |
|---|---|---|---|
| | Material | (λ = 550 nm) | thickness (nm) |
| Fourth layer | Hollow MgF₂ | 1.25 | 0.234 λ |
| Third layer | SiO₂ | 1.46 | 0.030 λ |
| Second layer | Ta₂O₅ | 2.11 | 0.039 λ |
| First layer | SiO₂ | 1.46 | 0.094 λ |
| Substrate | S-LAH66 | 1.78 | |

### Example 7

In Example 7, on a substrate of the trade name of S-LAH65v (OHARA INC., trade name, the refractive index of the material is 1.81 (wavelength λ=550 nm)), an antireflection coating having the construction shown in FIG. 1 was produced so as to have a film construction shown in Table 7. The first layer 1 to the third layer 3 were formed by the vacuum deposition method. For the fourth layer 4, the coating with a hollow MgF₂ mixed and prepared liquid was performed by the spin coater, and thereafter, the film formation was performed by a one-hour baking. The main component of the first layer 1 was Al₂O₃, the main component of the second layer 2 was Ta₂O₅, and the main component of the third layer 3 was SiO₂.

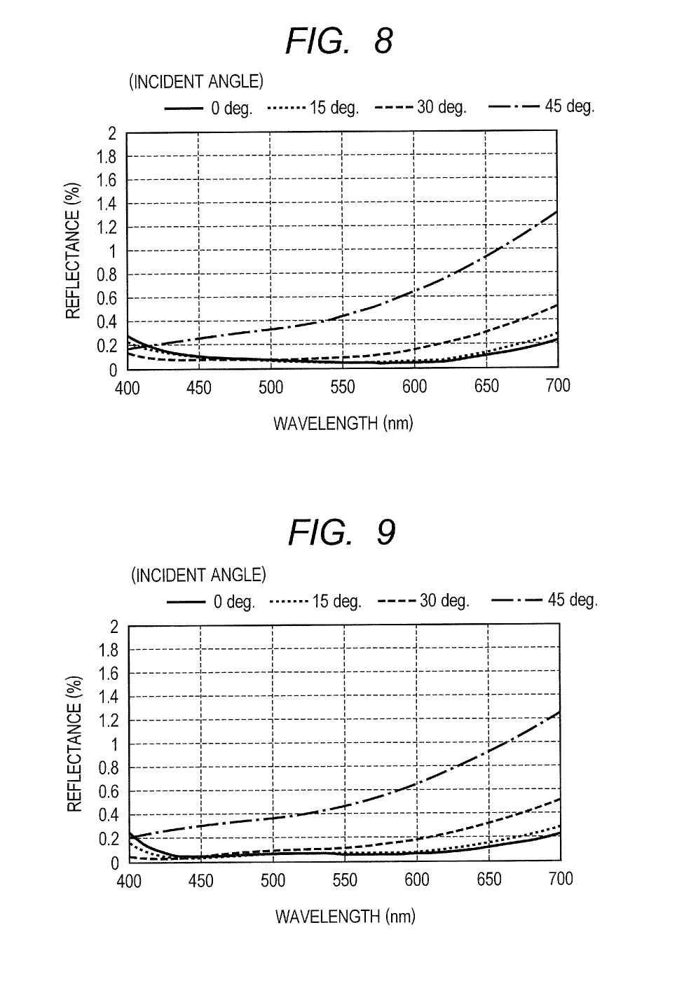

FIG. 8 illustrates the reflectance characteristics at incident angles of 0 degrees, 15 degrees, 30 degrees and 45 degrees, in a wavelength range of 400 nm to 700 nm. In the antireflection coating according to the example, in the wavelength range of 400 nm to 700 nm, the maximum value of the reflectances at the incident angles of 0 degrees, 15 degrees and 30 degrees was 0.6% or less, and even at the incident angle of 45 degrees, the reflectance was 1.4% or less. It is found that the antireflection coating according to the example is a high-performance antireflection coating having a high anti-reflection effect in the broadband.

TABLE 7

| | | Refractive index | Optical film |
|---|---|---|---|
| | Material | (λ = 550 nm) | thickness (nm) |
| Fourth layer | Hollow MgF₂ | 1.20 | 0.185 λ |
| Third layer | SiO₂ | 1.46 | 0.185 λ |
| Second layer | Ta₂O₅ | 2.04 | 0.037 λ |
| First layer | Al₂O₃ | 1.63 | 0.091 λ |
| Substrate | S-LAH65v | 1.81 | |

### Example 8

In Example 8, on a substrate of the trade name of S-LAM51 (OHARA INC., trade name, the refractive index of the material is 1.70 (wavelength λ=550 nm)), an antireflection coating having the construction shown in FIG. 1 was produced so as to have a film construction shown in Table 8. The first layer 1 to the third layer 3 were formed by the vacuum deposition method. For the fourth layer 4, the coating with a hollow MgF₂ mixed and prepared liquid was performed by the spin coater, and thereafter, the film formation was performed by a one-hour baking. The main component of the first layer 1 was SiO₂, the main component of the second layer 2 was Ta₂O₅, and the main component of the third layer 3 was MgF₂.

FIG. 9 illustrates the reflectance characteristics at incident angles of 0 degrees, 15 degrees, 30 degrees and 45 degrees, in a wavelength range of 400 nm to 700 nm. In the antireflection coating according to the example, in the wavelength range of 400 nm to 700 nm, the maximum value of the reflectances at the incident angles of 0 degrees, 15 degrees and 30 degrees was 0.6% or less, and even at the incident angle of 45 degrees, the reflectance was 1.4% or less. It is found that the antireflection coating according to the example is a high-performance antireflection coating having a high anti-reflection effect in the broadband.

TABLE 8

| | | Refractive index | Optical film |
|---|---|---|---|
| | Material | (λ = 550 nm) | thickness (nm) |
| Fourth layer | Hollow MgF₂ | 1.23 | 0.243 λ |
| Third layer | MgF₂ | 1.38 | 0.026 λ |
| Second layer | Ta₂O₅ | 2.04 | 0.038 λ |
| First layer | SiO₂ | 1.46 | 0.112 λ |
| Substrate | S-LAM51 | 1.70 | |

### Example 9

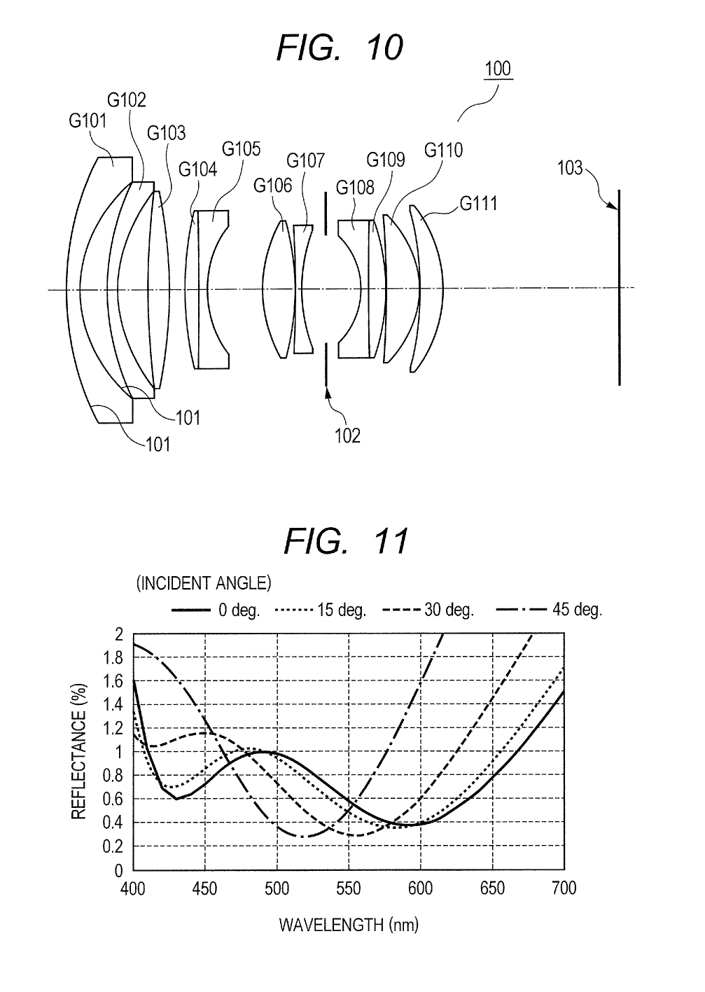

FIG. 10 is a schematic view of the principal part of an optical element provided with the antireflection coating according to the present invention and an optical system (imaging optical system) including the optical element. The optical element according to the present invention includes the substrate, and the above-described antireflection coating is provided on at least one of the light incidence surface and light emission surface of the substrate. The optical system according to the example is used in optical apparatuses such as a digital camera, a video camera and an interchangeable lens.

FIG. 10 illustrates an optical system 100, an imaging surface 103 on which a solid image pickup element (photo-electric conversion element) such as a CCD sensor and a CMOS sensor is disposed, an aperture stop 102, and lenses G101 to G111 that are optical elements. Among these lenses, in the lenses G101, G102, G103, G104, G106, G107, G108, G109 and G111, the refractive indexes ns of the materials are 1.6 or higher. On at least one of the incidence surface and emission surface of each lens, the antireflection coatings 101 (illustrated by the thick lines in the figure) according to the present invention are added.

The examples described above are just typical examples, and in the practice of the present invention, the examples can be altered and modified in various ways.

A numerical value example of the optical system 100 according to the present invention is shown below. In the numerical value example, i represents a surface order from the object side, ri represents the curvature radius of the i-th surface from the object side, di represents the interval between the i-th surface and i+1-th surface from the object side, ni and νi represent the refractive index and Abbe number of the i-th optical element, f represents the focal length, FNo represents the F-number, and ω represents the half angle of view (degree).

### Numerical Value Example 1

f=24.4 FNo=1.45 ω=41.4°
r01=60.187 d01=2.80 n1=1.69680 ν1=55.5
r02=30.193 d02=6.19
r03=59.602 d03=2.30 n2=1.69680 ν2=55.5
r04=91.983 d04=6.55
r05=194.761 d05=4.53 n3=1.67790 ν3=55.3
r06=−97.779 d06=3.68
r07=80.907 d07=2.80 n4=1.84666 ν4=23.9
r08=666.220 d08=1.70 n5=1.49700 ν5=81.6
r09=23.755 d09=11.64
r10=31.225 d10=7.37 n6=1.80400 ν6=46.6
r11=−57.233 d11=0.15
r12=−409.276 d12=1.89 n7=1.71736 ν7=29.5
r13=39.492 d13=5.04
r14=∞ (iris) d14=8.18
r15=−16.104 d15=1.50 n8=1.80518 ν8=25.4
r16=2532.956 d09=3.47 n9=1.83481 ν9=42.7
r17=−34.039 d10=0.15
r18=−190.746 d11=7.01 n10=1.61800 ν10=63.4
r19=−23.481 d12=0.15
r20=−74.015 d13=5.10 n11=1.77250 ν11=49.6
r21=−29.342

### Comparative Example 1

In Comparative Example 1 to the present invention, on a substrate of the trade name of S-LAH58 (OHARA INC., trade name, the refractive index of the material is 1.89 (wavelength λ=550 nm)), the first layer was optimized so as to be thicker than the range in the present invention. The film construction of an antireflection coating in Comparative Example 1 is shown in Table 9.

In this film construction, although the first layer was thicker than the range in the present invention, the second, third and fourth layers were within the range in the present invention. The first layer to the third layer were formed by the vacuum deposition method. For the fourth layer, the coating with a hollow SiO₂ mixed and prepared liquid was performed by the spin coater, and thereafter, the film formation was performed by a one-hour baking. The main components of the first layer 1 and the third layer 3 were Al₂O₃, and the main component of the second layer 2 was Ta₂O₅.

FIG. 11 illustrates the reflectance characteristics at incident angles of 0 degrees, 15 degrees, 30 degrees and 45 degrees, in a wavelength range of 400 nm to 700 nm. In the antireflection coating according to Comparative Example 1, in the wavelength range of 400 nm to 700 nm, at the incident angle of 0 degrees, even the minimum value is about 0.4%, and the reflectance characteristics are not very good. Therefore, unless the film thickness is set within the range of the conditional expressions according to the present invention, it is difficult to obtain a good anti-reflection effect.

TABLE 9

| | | Refractive index | Optical film |
|---|---|---|---|
| | Material | (λ = 550 nm) | thickness (nm) |
| Fourth layer | Hollow SiO₂ | 1.23 | 0.236 λ |
| Third layer | Al₂O₃ | 1.63 | 0.372 λ |
| Second layer | Ta₂O₅ | 2.12 | 0.039 λ |
| First layer | Al₂O₃ | 1.63 | 0.252 λ |
| Substrate | S-LAH58 | 1.89 | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-123275, filed Jun. 16, 2014 which is hereby incorporated by reference herein in its entirety.

1. An antireflection coating to be formed on a substrate,
the antireflection coating comprising a first layer, a second layer, a third layer and a fourth layer that are laminated in order from the substrate side to the air side,
the antireflection coating satisfying the following conditional expressions:
ns≧1.65
1.3≦n1≦1.7
n1≦ns
1.15≦n4≦1.30
0.018λ≦nl×d1≦0.125λ
0.18λ≦n4×d4≦0.27λ
where λ represents a reference wavelength of 550 nm, ns represents a refractive index of material of the substrate for the reference wavelength, n1 represents a refractive index of material of the first layer for the reference wavelength, d1 (nm) represents a physical film thickness of the first layer, n4 represents a refractive index of material of the fourth layer, and d4 (nm) represents a physical film thickness of the fourth layer.

2. The antireflection coating according to claim 1,
wherein the antireflection coating satisfies the following conditional expressions:
0.018λ≦n2×d2≦0.128λ
0.018λ≦n3×d3≦0.320λ
1.8≦n2≦2.2
1.3≦n3≦1.7
where n2 represents a refractive index of material of the second layer for the reference wavelength, d2 (nm) represents a physical film thickness of the second layer, n3 represents a refractive index of material of the third layer for the reference wavelength, and d3 (nm) represents a physical film thickness of the third layer.

3. The antireflection coating according to claim 1, wherein the fourth layer is a layer that includes voids.

4. The antireflection coating according to claim 1, wherein the fourth layer is a layer whose main component is hollow fine particles.

5. The antireflection coating according to claim 4, wherein the hollow fine particle is formed of one of silicon oxide and magnesium fluoride.

6. The antireflection coating according to claim 1, wherein the fourth layer is produced by a sol-gel method.

7. The antireflection coating according to claim 1, wherein the first layer to the third layer are produced by a vacuum deposition method or a sputtering method.

8. The antireflection coating according to claim 1, wherein the second layer is formed of at least one of oxides of titanium, tantalum, zirconia, chromium, niobium, cerium, hafnium and yttrium.

9. The antireflection coating according to claim 1, wherein the maximum value of reflectance of the antireflection coating is 0.6% or less, in a case of an incident angle of 0 degrees and a wavelength range of 400 nm to 700 nm.

10. An optical element comprising:
a substrate; and
an antireflection coating formed on the substrate, the antireflection coating comprising:
a first layer, a second layer, a third layer and a fourth layer that are laminated in order from the substrate side to the air side,
the antireflection coating satisfying the following conditional expressions:
ns≧1.65
1.3≦n1≦1.7
n1≦ns
1.15≦n4≦1.30
0.018λ≦nl×d1≦0.125λ
0.18λ≦n4×d4≦≦0.27λ
where λ represents a reference wavelength of 550 nm, ns represents a refractive index of material of the substrate for the reference wavelength, n1 represents a refractive index of material of the first layer for the reference wavelength, d1 (nm) represents a physical film thickness of the first layer, n4 represents a refractive index of material of the fourth layer, and d4 (nm) represents a physical film thickness of the fourth layer.

11. An optical system comprising:
an optical apparatus selected from the group consisting of a digital camera, a video camera, and an interchangeable lens; and
an optical element in the optical apparatus comprising:
a substrate; and
an antireflection coating formed on the substrate, the antireflection coating comprising:
a first layer, a second layer, a third layer and a fourth layer that are laminated in order from the substrate side to the air side,
the antireflection coating satisfying the following conditional expressions:
ns≧1.65
1.3≦n1≦1.7
n1≦ns
1.15≦n4≦1.30
0.018λ≦nl×d1≦0.125λ
0.18λ≦n4×d4≦0.27λ
where λ represents a reference wavelength of 550 nm, ns represents a refractive index of material of the substrate for the reference wavelength, n1 represents a refractive index of material of the first layer for the reference wavelength, d1 (nm) represents a physical film thickness of the first layer, n4 represents a refractive index of material of the fourth layer, and d4 (nm) represents a physical film thickness of the fourth layer.
